(19) United States
(12) Patent Application Publication
(10) Pub. No.: US 2024/0416275 A1
(43) Pub. Date: Dec. 19, 2024

(54) ACCELERATED CO2 REMOVAL BY ELECTROCHEMICAL OCEAN ALKALINITY ENHANCEMENT COUPLED WITH DIRECT AIR CAPTURE

(71) Applicant: Xiwang Qi, Scottsdale, AZ (US)

(72) Inventor: Xiwang Qi, Scottsdale, AZ (US)

(21) Appl. No.: 18/210,557

(22) Filed: Jun. 15, 2023

(51) Int. Cl. B01D 53/32; C02F 1/52

(52) U.S. Cl. CPC B01D 53/326; C02F 1/5236; B01D 2257/504; B01D 2259/80; C02F 2103/08; C02F 2209/06

(57) ABSTRACT

This invention relates to a method for accelerated CO₂ removal from air by coupling electrochemical Ocean Alkalinity Enhancement (OAE) and Direct Air Capture (DAC). The invention utilizes the ocean's own and nearly unlimited mineral resources (Mg and Ca) to capture and sequester the CO₂ facilitated by electrochemical OAE and DAC CO₂ enrichment synergy. No external chemicals or minerals are needed in the process which are often detrimental to the environment and marine ecosystem. The coupled OAE-DAC method of this invention provides an accelerated, low-cost and eco-friendly CO₂ removal technology which can be deployed along the coastlines as well as on cross-ocean ships and containers worldwide.

### CROSS-REFERENCE TO RELATED APPLICATION

This application claims priority of Provisional Application Ser. No. 63/354,440 filed in the United States Patent and Trademark Office on Jun. 22, 2022, and which addresses the same subject matter.

### FIELD OF THE INVENTION

This invention relates to a method for accelerated carbon dioxide (CO₂) removal from air by coupling electrochemical Ocean Alkalinity Enhancement (OAE) and Direct Air Capture (DAC). The captured CO₂ is sequestered permanently in the form of carbonate precipitates which gravitate to the ocean floor.

### BACKGROUND OF THE INVENTION

Climate change includes both global warming driven by human-induced emissions of greenhouse gases and the resulting large-scale shifts in weather patterns. Since the mid-20th century, humans have had an unprecedented impact on Earth's climate. Increases in temperature are leading to more frequent heat waves and wildfires in recent years, while melting permafrost, glacial retreat, and sea ice loss all pose significant environmental catastrophe if not addressed in the coming years.

The main greenhouse gas of concern is CO₂, which is emitted from the burning of fossil fuels (coal, oil, and natural gas) for energy consumption, as well as from activity in agriculture, deforestation, and manufacturing. The International Panel on Climate Change (IPCC) estimates that approximately 10 gigatons of net CO₂ removal per year by 2050 is needed to keep global temperatures from rising above 1.5-2° C. to avoid catastrophic climate change. It is commonly agreed that emissions reduction alone is not enough, and that society needs to employ new technologies like Direct Air Capture (DAC) and Ocean Alkalinity Enhancement (OAE) to collectively remove CO₂ out of the air at billion-ton scale to solve the imminent climate change problem.

Up until now, DAC technology is at its nascent stage and the CO₂ capture cost is still prohibitively high due to high energy cost and low efficiency of the capture process, which prevent it from large scale deployment. On the other hand, the oceans on earth already hold tens of thousands billion tons of carbon, and in theory they have enough capacity to store additional billions of tons of CO₂. In reality, CO₂ removal via ocean-atmosphere exchange mechanism is a very slow process (in decades) and limited by the gas-liquid chemical equilibrium at the current ocean pH level. Ocean alkalinity enhancement has the potential to increase the ocean sequestration capability by billion-ton scale in reasonable time (in years). The main approach involves adding finely ground alkaline substances such as alkaline chemicals or olivine rocks to seawater to increase the ocean's pH so as to remove more CO₂ from the atmosphere by converting dissolved CO₂ into stable bicarbonate and carbonate compounds. However, this approach has many concerns such as the cost associated with the extraction, processing, and application of alkaline substances (each ton of CO₂ removal requires processing roughly 1-3.5 tons of alkaline material), as well as the effectiveness and environmental damage considering the massive volume of sea water involved and the delicate marine ecosystem. Specifically, due to the sheer volume of the ocean, it will require billions of tons of alkali to be added to create a noticeable pH increase (say from the current 8.1 to 8.2). This could easily consume all the alkali capacity the world can produce or mine. Secondly, the local alkalinity enhancement by the alkali addition approach could quickly disappear by the wave, tide and ocean current dissipation effect before the slow ocean-air exchange process can happen. Thirdly, the local, short time pH spike (could be well above 10) by alkali addition could disrupt the nearby marine ecosystems and surrounding vegetation, fish, and corals. Thus the environmental risk is very high.

Therefore, it would be highly advantageous to develop an effective, faster and low-cost ocean-based air CO₂ capture and sequestration technology which is sustainable and eco-friendly for large-scale deployment along the oceans worldwide.

The present invention is to provide a novel approach by electrochemical ocean alkalinity enhancement technology coupled with direct air capture, which is much more efficient, cost-effective, sustainable and environmentally friendly as compared to existing alkali addition approach.

### SUMMARY OF THE INVENTION

This invention relates to a method for ocean-based accelerated CO₂ removal from air by electrochemical Ocean Alkalinity Enhancement (OAE) coupled with Direct Air Capture (DAC). The invention utilizes the ocean's own nearly unlimited mineral resources (Mg and Ca) to capture and sequester the CO₂ facilitated by electrochemical OAE and DAC CO₂ enrichment synergy. No external chemicals or minerals are needed in the process which are costly and often detrimental to the environment and the marine ecosystem. The CO₂ capture process by ocean is greatly accelerated by this invention of OAE-DAC coupled system and the CO₂ captured by this method is sequestered permanently in the form of carbonate precipitates which fall onto the ocean floor.

Briefly to achieve the desired objects and advantages of the invention, the method of accelerated CO₂ removal from air associated with this OAE-DAC coupled system is provided. The steps of the method include flowing sea water through a electrochemical OAE cell having an upstream anode and an opposing downstream cathode, flowing the alkalinity enhanced sear water out of the cathode side to a precipitator, bubbling the CO₂ enriched air from the DAC unit via a bubbler installed on the bottom portion of the precipitator to induce the precipitation reaction between dissolved CO₂ and the mineral ions (Mg²⁺ and Ca²⁺) in the sea water. The precipitates are in the form of insoluble carbonates which fall on the ocean floor and lock the captured CO₂ permanently. The highly porous nature of the anode and cathode structures allows the flow of sea water therethrough while ensuring contact with electrode materials. The CO₂ enriched air results in much greater driving force for gas phase CO₂ to be captured by the ocean minerals as compared to atmospheric air which contains only 0.04% of CO₂. Under carefully designed and controlled favorable conditions, the CO₂ is chemically bonded to Mg²⁺ and Ca²⁺ and the MgCO₃ and CaCO₃ precipitates are formed at a rate orders of magnitude faster than the normal ocean-air exchange process. The MgCO₃ and CaCO₃ precipitates gravitate to the ocean floor and therefore the CO₂ is permanently sequestered. As a result, this invention provides a greatly accelerated CO₂ capture and sequestration process with the ocean's nearly unlimited mineral sources (Mg, Ca). No external alkali chemical production or mining is needed which is both costly and environmentally hazardous and is potentially disruptive to marine ecosystem. Therefore, this invention could lead to a much more efficient, low cost and environmentally friendly technology for ocean-based CO₂ capture and sequestration.

### BRIEF DESCRIPTION OF THE DRAWING

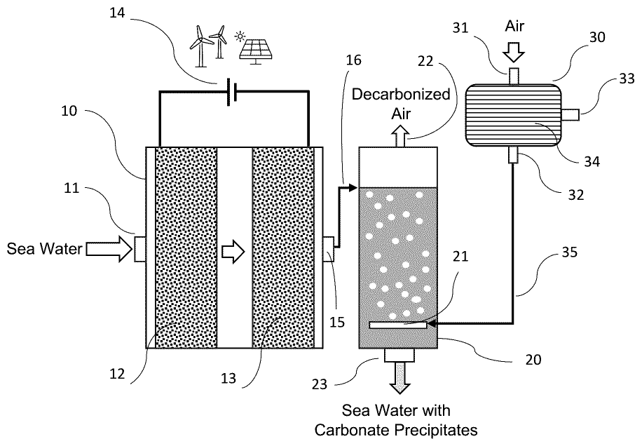

Specific objects and advantages of the invention will become readily apparent to those skilled in the art from the following detailed description of a preferred embodiment thereof, taken in conjunction with the drawing as shown in FIG. 1, a schematic view of an OAE-DAC coupled CO₂ capture system according to the present invention.

### DETAILED DESCRIPTION

This invention relates to a method of accelerated ocean-based CO₂ removal from air by coupling electrochemical Ocean Alkalinity Enhancement (OAE) and Direct Air Capture (DAC) technology. Now referring to FIG. 1, which illustrates an electrochemical OAE unit 10 coupled with a DAC unit 30 through a precipitator device 20. OAE unit 10 is an electrochemical cell powered by renewable energy source 14 such as solar and wind generated DC electricity. The sea water comes into the cell from upstream inlet 11 flowing through anode 12 then cathode 13 and exits at the downstream outlet 15. The OAE unit processes the sea water in a manner that the local alkalinity enhancement is created around the cathode by electrochemical force. The alkalinity enhanced sea water 16 from the OAE cathode is continuously pumped into precipitator 20 where a CO₂ enriched air flow 35 from the coupled DAC unit 30 is bubbled through the alkalinity enhanced sea water containing Mg²⁺/Ca²⁺ ions inside the precipitator, thus providing an ideal condition for gas-liquid absorption and accelerated chemical bonding of CO₂ with mineral ions during which precipitates CaCO₃ and MgCO₃ are formed. The sea water slurry with insoluble CaCO₃ and MgCO₃ is discharged via outlet 23 and goes back to ocean where the solid precipitates fall onto the ocean floor and the captured CO₂ thus is permanently stored. The decarbonized air 22 exits at the top of precipitator 20 and goes back to atmosphere.

Direct air capture (DAC) unit 30 is a CO₂ capture device operating and removing CO₂ from the atmosphere (ambient air) which typically has a low CO₂ concentration of approximately 400 ppm. DAC unit 30 includes an air inlet 31, a CO₂ enriched air outlet 32, a CO₂ depleted air outlet 33 and a chamber 34 carried in between inlet 31 and outlet 32 housing solid CO₂ sorbent or CO₂ enrichment membrane cartridges. Atmospheric air flows from inlet 31 through chamber 34 and is separated into two streams, CO₂ enriched air exiting through outlet 32, and CO₂ depleted air exiting through outlet 33 and going back to atmosphere. To draw atmospheric air through chamber 34, a motor fan is normally needed. CO₂ enriched air flow 35 is ducted into bubbler 21 installed at the bottom portion of the precipitator 20. The bubbler 21 is designed to generate small bubbles of CO₂ enriched air in the alkalinity enhanced sea water body in the precipitator, allowing fast gas-liquid mass transport process during which the CO₂ dissolves into the sea water and quickly reacts with Ca²⁺ and Mg²⁺ ions under basic pH condition to form carbonate precipitates.

The mechanism of accelerated CO₂ removal in this invention is to maximize the synergetic chemistry of both thermodynamic and kinetic aspects of the CO₂ reaction with ocean's natural mineral ions of Ca²⁺/Mg²⁺ by creating a local favorable conditions, most notably controlling the CO₂ partial pressure in gas phase and the pH level in liquid phase of sea water in precipitator within the optimal range. As shown by the main equations below:

CO₂+H₂O↔HCO₃⁻+H⁺ (1)

CO₂+OH⁻↔HCO₃⁻ (2)

Mg²⁺+HCO₃⁻→MgCO₃(s)+H⁺ (3)

Ca²⁺+HCO₃⁻→CaCO₃(s)+H⁺ (4)

Eq. (1) and (2) depict the process of CO₂ dissolving into water and creating bicarbonate ions under acidic/neutral and basic conditions respectively. The bicarbonate ion is a crucial intermediate which concentration determines the productivity of the subsequent carbon sequestration reactions as shown by Eq. (3) and (4). By creating both high gas phase CO₂ partial pressure (utilize CO₂ enriched air from DAC unit) and basic pH sea water (via cathode reaction of OAE unit), the bicarbonate ion formation rate as well as the insoluble carbonate formation rate in Eq. (3) and (4) could be improved by orders of magnitude as compared to ocean's natural CO₂ absorption process. Mg²⁺ and Ca²⁺ are the two most abundant metal ions in the sea water only after Nat, with ion concentrations at 1350 mg/L and 412 mg/L respectively, which provide nearly unlimited carbon sink in the form of MgCO₃ and CaCO₃ solid precipitates under the conditions created by this invention.

The electrochemical OAE unit 10 in this invention consists of porous anode and cathode made of nanostructured carbon material in which nanocatalysts are embedded. The oxidation and reduction reactions at the electrodes are greatly boosted by the nanocatalyzed nanostructured carbon electrodes under sea water environment which acts as a natural electrolyte. The nanocatalysts are chosen from a group consisting of iron, cobalt, nickel, copper, zinc, silver, phosphorus, manganese, platinum, palladium, rhodium, ruthenium, cerium, their corresponding oxides, and combinations. The highly porous electrodes are made into physical forms of foam plate or honeycomb monolith with go-through channels which allow sea water flowing through the electrodes. The electrochemical cell is driven by DC power with applied voltage ranging from 0.5 V to 5 V, preferably in the range of 1.0 V to 2.5 V, supplied by renewable solar or wind power sources. The pH value of the alkalinity enhanced sea water 16 coming out of the OAE unit is preferably in the range of 8.5˜ 10, most preferably from 9 to 9.5, under which the solubilities of MgCO₃ and CaCO₃ are negligible, and yet the Mg(OH)₂ formation and cathode pore blockage by the hydroxide precipitate is prohibited.

As an example, a pair of porous nanostructured carbon anode and cathode with embedded nanocatalysts of Cu and Ce were synthesized into round honeycomb monolith disks with 8.2 cm diameter and 2 cm thickness. An electrochemical OAE cell was constructed with the above prepared anode and cathode and a digital variable DC power supply (Kaiweets Technology, HK). 400 g simulated sea water (3.5% sea salt) was circulated at a flow rate of 60 ml/min through the OAE cell while a 1.5 V DC voltage was applied. The pH of sea water from the cell outlet changed from ˜7 to 9.5 in one minute after the 1.5 V DC power was turned on, and the basic 9.5 pH value was maintained during the rest of testing which lasted for 10 min. This test proved the feasibility of the electrochemical OAE method and the nanostructured carbon electrodes of this invention.

The DAC unit 30 in this invention is a solid sorbent or membrane-based DAC module which provides CO₂ enriched air flow to the precipitator where the CO₂ enriched air is bubbling into the alkalinity enhanced sea water for rapid CO₂ capture by Mg²⁺ and Ca²⁺ ions via chemical bonding into carbonate precipitates. The solid sorbent-based DAC module has the advantage of providing high concentration of CO₂ (>20%, depending on the desorption method used), but only during the periodical CO₂ desorption process. A dual sorbent module DAC unit is needed to provide continuous CO₂ enriched air flow. The membrane-based DAC module has the advantage of providing continuous CO₂ enriched air flow, but the CO₂ concentration is normally much lower than sorbent-based DAC output. A preferred CO₂ enrichment factor for sorbent or membrane-based DAC module should be at least 5X, i.e., the air flow coming out of the DAC module contains at least 0.2% CO₂, most preferably in the range of 1˜ 40%.

The method of OAE coupled with DAC of this invention as described above provides an accelerated, low-cost and eco-friendly CO₂ removal technology by using the ocean's nearly unlimited mineral sources and can be deployed along the worldwide coastlines as well as on the cross-ocean ships and containers. While the primary application of this invention is to capture CO₂ from the air source via coupled OAE-DAC system, it should be noted that the CO₂ source in this invention is not limited to atmospheric air, it can also be from point source CO₂ emissions in places such as power plants, cement and steel manufacturers, as well as transportation and oil and gas industries and the like.

The present invention is described above with reference to illustrative embodiment. Those skilled in the art will recognize that changes and modifications may be made in the described embodiment without departing from the nature and scope of the present invention. Various changes and modifications to the embodiment herein chosen for purposes of illustration will readily occur to those skilled in the art. To the extent that such modifications and variations do not depart from the invention, they are intended to be included within the scope thereof.

1. A method for accelerated CO₂ removal from air by electrochemical Ocean Alkalinity Enhancement (OAE)-Direct Air Capture (DAC) coupled system comprising the steps of:
providing an electrochemical cell as the OAE device having an upstream porous anode and a downstream porous cathode powered by renewable DC power sources such as solar and wind generated electricity, with sea water continuously flowing through the cell and the electrodes and creating alkalinity enhanced sea water around the cathode by electrochemical reduction reactions;
providing a DAC module producing continuous CO₂ enriched air flow by processing atmospheric air;
providing a precipitator to which the alkalinity enhanced sea water from OAE unit is fed at the top to contact with the bubbling CO₂ enriched air from the DAC unit in a counterflow mode, during the gas-liquid phase interaction process the CO₂ is chemically bonded with Mg²⁺/Ca²⁺ ions in the sea water to form MgCO₃ and CaCO₃ precipitates, thus the CO₂ is permanently sequestered as insoluble carbonates deposited on ocean floor.

2. The electrochemical OAE-DAC coupled system according to claim 1, wherein said porous anode and cathode are made of nanostructured carbon material in which nanocatalysts are embedded.

3. The electrochemical OAE-DAC coupled system according to claim 1, wherein said porous anode and cathode are made into physical forms of foam plate or honeycomb monolith with go-through channels which allow sea water flowing through the electrodes.

4. The electrochemical OAE-DAC coupled system according to claim 1, wherein said electrochemical cell is driven by DC power with applied voltage ranging from 0.5 V to 5 V, preferably in the range of 1.0 V to 2.5 V, supplied by renewable solar or wind power sources.

5. The electrochemical OAE-DAC coupled system according to claim 1, wherein said alkalinity enhanced sea water coming out of the OAE unit has a pH value preferably in the range of 8.5˜10, most preferably from 9 to 9.5.

6. The electrochemical OAE-DAC coupled system according to claim 1, wherein said DAC module is a membrane-based DAC module, or alternatively a dual solid sorbent module DAC unit, which provides continuous CO₂ enriched air flow to the precipitator.

7. The electrochemical OAE-DAC coupled system according to claim 1, wherein said DAC module has a CO₂ enrichment factor of at least 5X, i.e., the air flow coming out of the DAC module contains at least 0.2% CO₂, preferably in the range of 1˜ 40%.

8. The electrochemical OAE-DAC coupled system according to claim 1, wherein said precipitator has a bubbler installed at the bottom section to generate small bubbles of CO₂ enriched air in the alkalinity enhanced sea water body in the precipitator, allowing fast gas-liquid mass transport process and chemical reactions between CO₂ and Ca²⁺/Mg²⁺ ions to form carbonate precipitates.

9. The electrochemical OAE-DAC coupled system according to claim 1, wherein said precipitator has an outlet port at the bottom to discharge the sea water slurry with CaCO₃ and MgCO₃ precipitates back to ocean, where the solid precipitates gravitate to the ocean floor and the captured CO₂ is permanently sequestered.

10. The electrochemical OAE-DAC coupled system according to claim 2, wherein said nanocatalysts are chosen from a group consisting of iron, cobalt, nickel, copper, zinc, silver, phosphorus, manganese, platinum, palladium, rhodium, ruthenium, cerium, their corresponding oxides, and combinations.
